(19) United States
(12) Patent Application Publication
(10) Pub. No.: US 2026/0287012 A1
(43) Pub. Date: Sep. 24, 2026

(54) Device for Forming a Sliding Bearing or a Slip-Ring Seal Having Integrated Temperature Measurement

(71) Applicant: KSB SE & Co. KGaA, Frankenthal (DE)

(72) Inventors: Gerd EBELT, Frankenthal (DE); Boris JANJIC, Frankenthal (DE); Tobias KLUNKE, Frankenthal (DE); Michael KOLANO, Frankenthal (DE)

(21) Appl. No.: 19/474,299

(22) PCT Filed: Apr. 11, 2024
(86) PCT No.: PCT/EP2024/059792

§ 371 Date: Oct. 10, 2025

(30) Foreign Application Priority Data
Apr. 11, 2023 (DE) 10 2023 109 020.8

(51) Int. Cl. F16C 17/24; F04D 1/00; F04D 27/00; F04D 29/12; F16C 17/02; F16C 43/02

(52) U.S. Cl. CPC F16C 17/243; F04D 1/00; F04D 27/001; F04D 29/126; F16C 17/022; F16C 43/02; F16C 2206/56; F16C 2220/60; F16C 2240/06; F16C 2240/12; F16C 2240/26; F16C 2240/46; F16C 2360/44

(57) ABSTRACT

A device for forming a sliding bearing or a slip-ring seal includes at least two components which move relative to one another. A first component is a stationary component and a second component is movable relative to the first component. The first component has a sliding face facing the moving component. At least one measurement sensing element of at least one temperature sensor for the temperature-based condition monitoring of the device is embedded at least partially in the first component.

### CROSS REFERENCE TO RELATED APPLICATION

This application is a 371 National Stage Application of PCT/EP2024/059792, filed Apr. 11, 2024, which claims priority from German Patent Application No. 102023 109020.8, filed Apr. 11, 2023, the entire disclosure of which is herein expressly incorporated by reference.

### BACKGROUND

The disclosure relates to a device for forming a sliding bearing or a slip-ring seal having integrated temperature measurement, wherein the device has at least two components that are movable relative to one another, wherein a first component is stationary and a second component is movable relative to the first component, and wherein the first component has a sliding face facing the movable component.

Slip-ring seals and sliding bearings are used in rotating work machines, such as, for example, compressors, pumps, motors, for sealing and mounting a rotating shaft of the work machine. The construction of a sliding bearing and of a slip-ring seal is comparable. Two components that rotate relative to one another form the base, wherein a first component is fixed stationarily to the machine, while the rotating component is seated on the shaft of the work machine and rotates relative to the stationary component. Associated sliding faces slide on one another. A fluid for cooling and lubricating the bearing or the seal may be provided between the sliding faces. In the case of a slip-ring seal, the stationary component is referred to as the counter ring.

As a result of the relative sliding movement, wear occurs on both components during operation and can lead to a functional impairment or even complete failure. Against this background, it is already known to monitor the condition of the bearing or seal continuously in order to be able to recognize and signal an impending bearing or seal defect in good time. Thus, it is already known to detect and monitor the temperature of the seal or bearing components. The temperature development in the immediate region of the sliding faces, i.e. in the region of the seal gap or bearing gap, is particularly important here. Since a direct measuring point in the region of the sliding face is not possible for functional reasons, the temperature sensors have therefore hitherto been mounted on the rear side of the counter ring in order to measure the surface temperature of the rear side of the counter ring.

Depending on the material thickness of the counter ring and characteristic material properties such as thermal conductivity and thermal capacity, a temperature measurement is thus possible with only limited accuracy. In addition, transient temperature profiles can neither be detected nor evaluated.

### SUMMARY

An object of the present disclosure consists, therefore, in optimizing the prior-known measuring method in order to allow better monitoring of the sliding bearing or slip-ring seal overall.

According to the disclosure there is proposed a device which comprises a known sliding bearing or a known slip-ring seal and which has been modified for temperature measurement. It is proposed that at least one measurement sensing element of a temperature sensor for the temperature-based condition monitoring of the device is not installed on a surface of the stationary bearing component or seal component but instead is embedded in the stationary component. By embedding the measurement sensing element, the measuring point can be moved closer to the relevant sliding face of the stationary component, so that the temperature present at the sliding face of the bearing or of the seal can be detected significantly more accurately. In addition, rapid temperature changes, in particular transient jumps in the region of the sliding face, can thus better be recognized and evaluated. Overall, because the measurement sensing element is positioned closer to the sliding face, the characteristic material properties of the component have less of an influence on the measurement result.

According to an advantageous embodiment, the device is a slip-ring seal and the first component is the counter ring of the slip-ring seal. It is also conceivable for the device to be a sliding bearing and for the first component to correspond to a bearing ring or other stationary bearing part.

Advantageously, the at least one measurement sensing element of the at least one temperature sensor is introduced into the volume of the first component from a counter face of the first component opposite the sliding face of the first component, i.e. the component has a cavity that is accessible from the opposite counter face and into which the measurement sensing element can be introduced during assembly. It is, however, also possible to introduce the one or more temperature sensors into the component from another, non-sliding face, for example from a surface that is at right angles to the sliding face.

It is essential for the disclosure that at least the measurement sensing element of the at least one temperature sensor is introduced into the component volume. For the introduction of the at least one measurement sensing element of the temperature sensor, one or more pocket-forming recesses can be provided on the surface of the counter face or on a further, non-sliding face, into which recesses the measurement sensing element(s) can be inserted or introduced during installation. The measurement sensing element can be, for example, a temperature-dependent resistor. For the remainder of the sensor electronics there can be provided, for example, a sensor board modeled on a portion of the counter face. The measurement sensing elements are electrically contacted with the board, wherein the resistor elements are, however, inserted into the corresponding component volumes and the board lies flat on the counter face, in particular is adhesively bonded to the component over a large area. The board can additionally have one or more holes in order to increase the mechanical stability of the adhesive bonding.

On the exposed side of the board, connection pads for external contacting of the sensor can be provided. Alternatively, the integration of a sensor with direct cable connection is also conceivable.

The first component is preferably manufactured from a material with high thermal conductivity and/or low thermal capacity, so that the temperature prevailing at the sliding face can be detected at the at least one measuring point as accurately and with as little delay as possible. It is conceivable, for example, for the first component to be manufactured from a ceramics material, in particular a technical ceramics. Particularly preferably, the first component is manufactured from silicon carbide, particularly preferably sintered from silicon carbide.

It is appropriate for the temperature detection that multiple temperature sensors, or measurement sensing elements, are arranged offset relative to one another in the component. Preference is given here to a distributed arrangement of the individual measurement sensing elements at a constant distance from one another. If the first component is a ring, it is appropriate to arrange the individual measurement sensing elements offset relative to one another by an identical angular offset. A suitable possible angle range here is a range between 80 degrees and 100 degrees, in particular about 90 degrees.

In addition to the device according to the disclosure, the disclosure relates also to a rotating work machine, preferably a pump, in particular a centrifugal pump, particularly preferably a glandless pump, having a device according to the present disclosure. Consequently, the work machine, in particular the pump, comprises at least one shaft which is mounted radially or axially by means of a sliding bearing and/or is sealed with respect to a wall of the work machine, in particular with respect to the housing wall, by means of a slip-ring seal. The at least one sliding bearing or the at least one slip-ring seal corresponds to the device according to the disclosure.

In addition, the disclosure also includes a system consisting of at least one work machine according to the disclosure and an additional evaluation unit, which is configured to receive the measured temperature values of the at least one temperature sensor and to monitor the condition of the sliding bearing or of the slip-ring seal on the basis of the received measured temperature values. In addition to the measured temperature values, further operating parameters of the work machine can be detected by means of sensors, or alternatively estimated or calculated. Further operating parameters are the instantaneous rotational speed of the rotating shaft and/or the temperature of a fluid conveyed through the work machine, or of the fluid located in the region of the sliding bearing or of the slip-ring seal. It may also be expedient to detect the pressure of a fluid acting on the sliding bearing or the slip-ring seal and to take the pressure value into consideration when monitoring the bearing or the seal.

The above-mentioned one or more operating parameters can be analyzed by the evaluation unit together with the measured temperature value in order to determine the instantaneous bearing or seal condition. Preferably, the condition monitoring takes place on the basis of a model-based analysis of the bearing or of the seal.

It is particularly preferred for the evaluation unit to be configured to recognize and analyze transient phenomena in the measured temperature profile. The novel integration of the measurement sensing elements into the volume of the component of the bearing or of the seal creates for the first time the necessary prerequisite for the reliable detection and subsequent evaluation of these highly dynamic temperature changes or fluctuations. Thus, by means of the system, not only is it possible to evaluate unsteady temperature profiles in a simple manner, but brief, highly dynamic, transient temperature jumps can also be recognized and evaluated.

In particular, it is expedient for the evaluation unit to comprise at least one memory in which predefined correlation information between the temperature at the sliding face and at the measuring point of the at least one measurement sensing element is stored. The correlation is dependent on the material, on the overall geometry of the component and on the distance and is distinguished in particular by a predefined relationship. Using the correlation information, the temperature at the sliding face can be determined.

It is conceivable for the disclosure for the evaluation unit to be integrated directly in the work machine, for example in an integral machine controller of the work machine, for example in the pump controller or motor controller. It is further conceivable for a controller of the work machine to ascertain the at least one measured temperature value and optionally at least one further operating parameter and to transmit these to an external evaluation unit via a communication interface. The outsourced evaluation and monitoring of the bearing condition or seal condition then takes place in the external evaluation unit. It is here conceivable for the evaluation unit to be implemented by a cloud-based solution.

In addition to the devices according to the disclosure, the present disclosure relates also to a method for producing the device according to the disclosure. It is here proposed to treat the first component, which has been manufactured beforehand, by means of a machining method in order to create one or more pocket-like recesses on a component surface, or on the counter face. The corresponding measurement sensing elements can then be inserted into these pocket-like recesses in a subsequent assembly step, wherein the one or more measurement sensing elements are connected together via a common sensor board.

The sensor electronics board is adhesively bonded to the surface of the component, for example, while the measurement sensing elements, in particular the temperature-dependent resistors, are inserted into the pockets which have been formed The recesses can preferably be produced by means of laser ablation.

Further advantages and properties will be explained in greater detail below by means of representations in figures, in which:

### BRIEF DESCRIPTION OF THE DRAWINGS

FIG. 1 is a top view of the counter ring of a slip-ring seal according to the disclosure,

FIG. 2 is a sectional representation along the section axis A-A in FIG. 1,

FIG. 3 is a partial representation of the counter ring with mounted sensor electronics,

FIG. 4 is a measurement diagram of the temperature detected on the rear side of the counter ring over a period of 8 days,

FIGS. 4a, 4b, 4c are parts of the measurement diagram of FIG. 4,

FIG. 5 is a measurement diagram of the temperature profile, showing the rotational speed of the pump drive for comparison,

FIG. 6 is a comparison of the measured temperature values with further operating parameters of the pump,

FIG. 7 is a diagrammatic representation illustrating the correlation between the seal gap temperature and the temperature on the rear side, and

FIG. 8 is a representation of a system for monitoring slip-ring seals on the basis of the temperature sensor system according to the disclosure.

### DETAILED DESCRIPTION

The disclosure will be explained by way of example hereinbelow with reference to a counter ring for a slip-ring seal, as can be used in a pump. The counter ring is manufactured from a SSiC. An annular end face of the counter ring serves as a counter face, which faces a rotating slip ring of the seal. On the opposite annular face, i.e. on the rear side of the counter ring, pocket-like grooves have been introduced into the rear annular face by means of a laser ablation process.

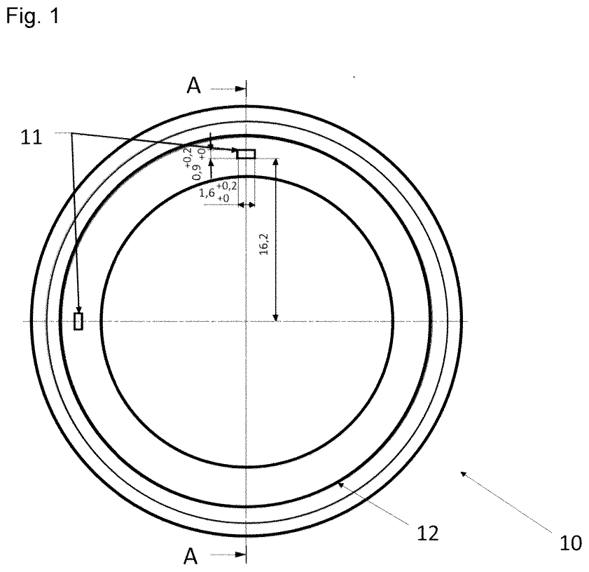

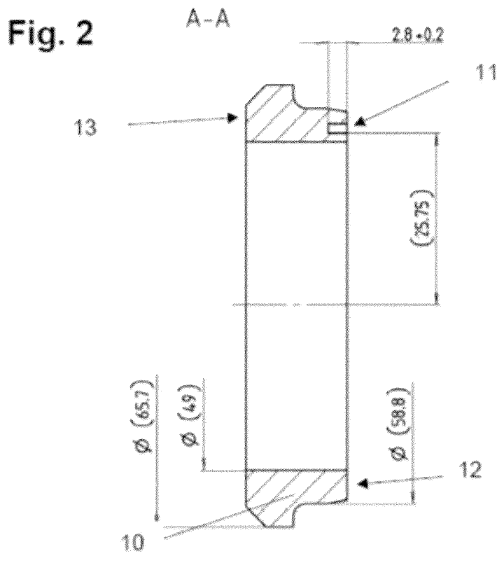

A representation of the post-processed counter ring 10 can be seen in FIGS. 1, 2. The sliding face of the counter ring 10 is marked by reference sign 13. On the opposite annular face, i.e. the rear side 12 of the counter ring 10, there are provided two pockets 11 arranged with an angular offset of 90 degrees, said pockets having been introduced into the rear side 12 by means of a laser ablation process.

The depth of the pocket 11 is matched to the height of the measurement sensing element that is to be introduced and is between 1.5 mm and 3.5 mm; in the exemplary embodiment shown, the depth is approximately 2.8 mm. The height of the pocket can be between 2 mm and 3 mm, in particular approximately 2.5 mm. The width can be between 1 mm and 2 mm, in particular approximately 1.4 mm.

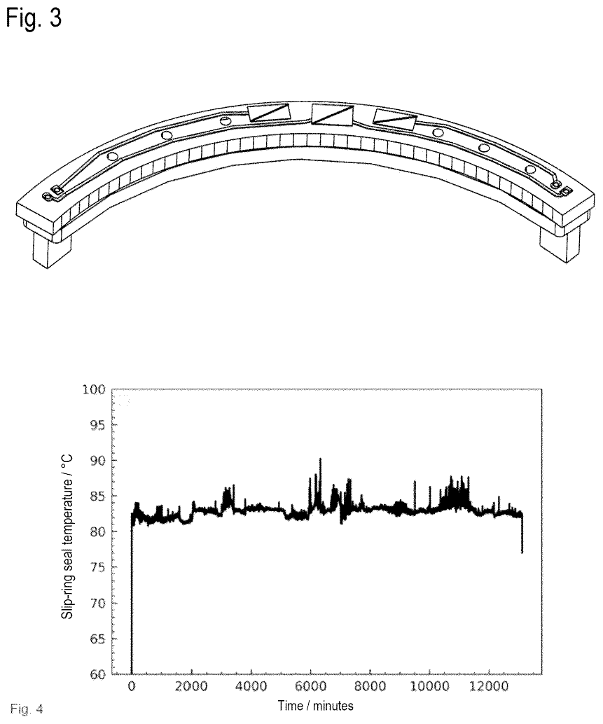

FIG. 3 shows a portion of the counter ring with the sensor board 20 adhesively bonded to the rear side 13. The shape of the sensor board 20 is matched to the annular face of the rear side of the counter ring. At the ends 23, temperature-dependent resistor elements, for example PT1000 chips, have been soldered to the side of the board that faces the rear side 12 of the counter ring 10. The chips extend perpendicularly from the board 20 into the associated pockets 11 of the counter ring 10. Via lines 22 on the rear side of the board, the resistors are connected to the connection pads 21, which are provided for external connection of the sensor to an external controller. In principle, a solution without a board also comes into consideration, in which the resistor elements are introduced directly into the pockets 11. The connection cables of the resistor cables are then guided out of the pockets and serve for external connection.

The board can be provided with multiple additional drilled holes for better fixing of the board to the counter ring. The board is adhesively bonded to the counter ring by means of a 2K adhesive, for example Duralco 4703. The pockets are additionally sealed by means of the applied adhesive. The finished sensor system permits condition monitoring or condition detection and interpretation of slip-ring seals on the basis of a temperature measurement. Monitoring can optionally be expanded by data fusion algorithms and a simulative model calculation of the system “slip-ring seal”.

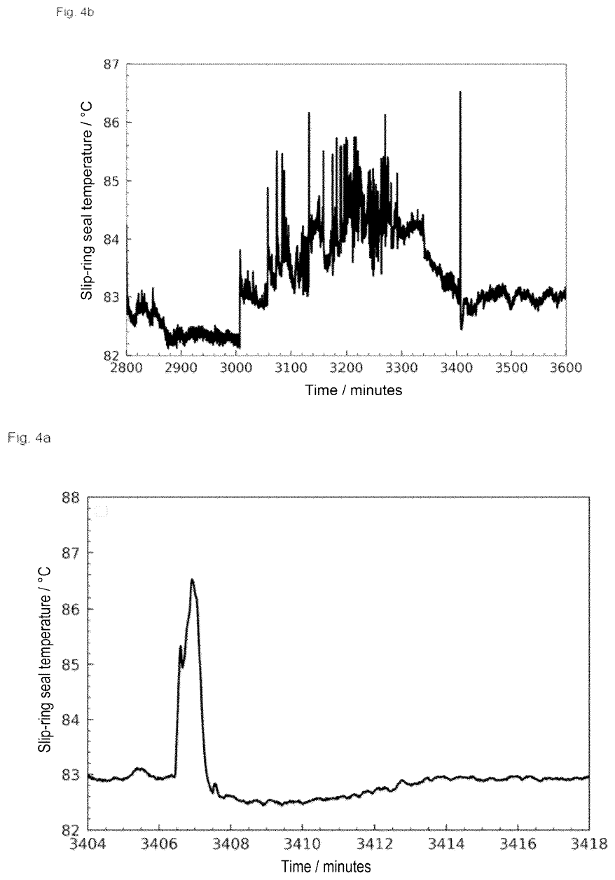

Owing to the very good thermal conductivity and the low thermal capacity of the SSiC counter ring, it is possible to detect, in addition to pronounced and dynamic increases in the temperature (as occur, for example, in the case of conventional dry running), also unsteady conditions of the system “slip-ring seal”. FIGS. 4, 4a, 4b, 4c show an endurance measurement of a slip-ring seal of a pump in the case of a water medium temperature of 80° C. Unsteady and fluctuating phases of the temperature are clearly visible, and these are reproduced in an enlarged representation in FIGS. 4a, 4b and 4c. The time constants and characteristics are here different, i.e. FIGS. 4a, 4b and 4c show different events, each of which represents an individual condition class of the slip-ring seal.

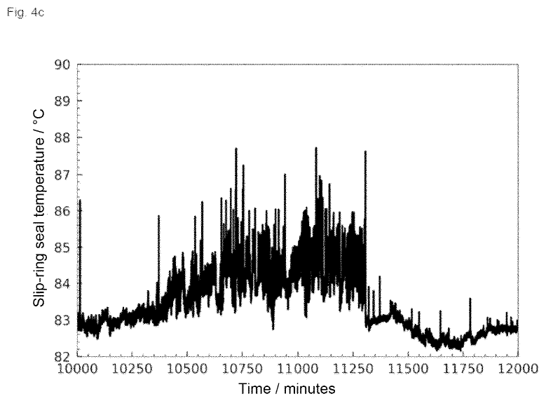

FIG. 5 shows, in addition to the transient temperature phenomena, the rotational speed of the test rig recorded using a rotational speed sensor, i.e. the rotation velocity of the slip-ring seal. In practice, this rotational speed would correspond to the rotational speed of the pump. It can clearly be seen that the rotational speed decreases temporarily while at the same time the temperature of the slip-ring seal increases, which can be explained by an increased friction moment.

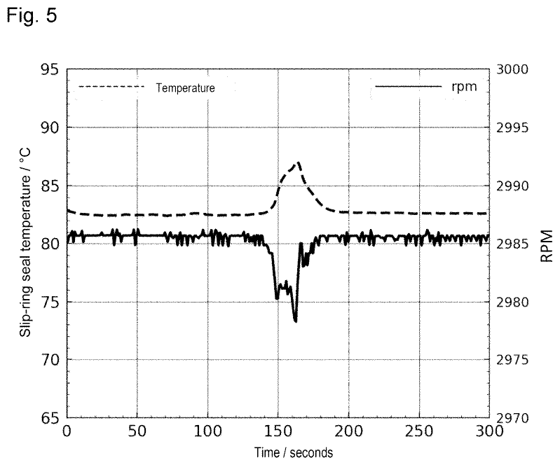

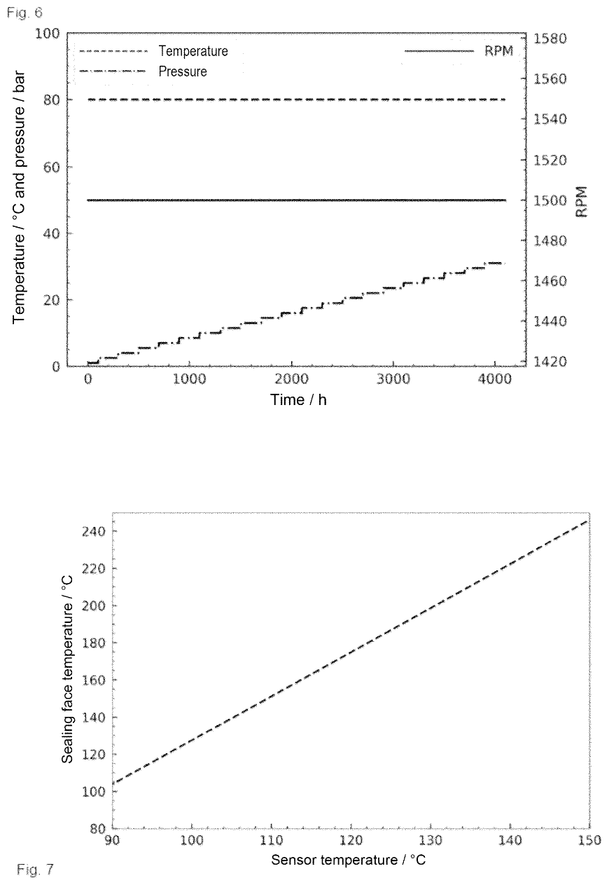

For evaluating and classifying the results described above (FIGS. 4a, 4b, 4c), simulation techniques can meaningfully be combined with the sensor system. FIGS. 6, 7 show the simulation results of an analysis of the seal gap temperature and rear side temperature of the stationary counter ring. The correlation of the corresponding temperatures in dependence on the pressure acting on the slip-ring seal can clearly be seen.

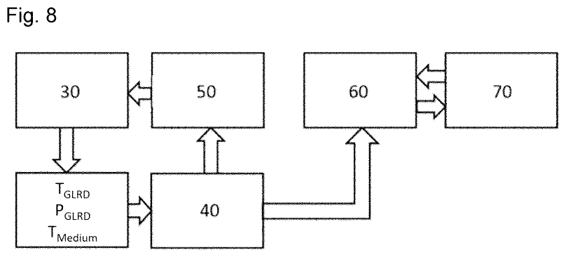

FIG. 8 additionally shows a possible system construction for monitoring a slip-ring seal in a centrifugal pump. In the centrifugal pump 30, the temperature T_{GLRD} of the counter ring 10 is detected by means of the device according to the disclosure. In addition to the measured temperature values, the pressure P_{GLRD} on the slip-ring seal and the instantaneous temperature T_{Medium} of the conveyed medium are additionally detected by means of sensors.

The detected parameters are communicated to an evaluation electronics 40, which determines the condition of the slip-ring seal on the basis of the received operating parameters, in particular by evaluating transient temperature changes. If relevant events that signify a critical condition of the slip-ring seal are recognized by the electronics, a signal can be transmitted to a pump controller 50, which performs a control intervention in the pump operation.

At the same time, the evaluation unit can transmit its analysis results to a remote service portal 60, in order to carry out higher-level monitoring of a pump fleet. As an alternative to the decentralized solution with an evaluation unit close to the pump, the evaluation unit could also be integrated in the service portal 60. In this case, a pump controller transmits the measured parameters T_{GLRD}, P_{GLRD}, T_{Medium} to the service portal 60 for evaluation. The service portal 60, which may be cloud-based, can additionally be connected to an external portal 70 of the seal manufacturer for information exchange.

1.-14. (canceled)

15. A device for forming a sliding bearing or a slip-ring seal, comprising:
at least two components which move relative to one another, wherein
a first component is a stationary component and a second component is movable relative to the first component,
the first component has a sliding face facing the second component, and
at least one measurement sensing element of at least one temperature sensor for the temperature-based condition monitoring of the device is embedded at least partially in the first component.

16. The device of claim 15, further comprising: a counter ring, wherein the device is a slip-ring seal and the first component corresponds to the counter ring of the slip-ring seal.

17. The device of claim 15, wherein the at least one measurement sensing element is embedded in a counter face of the first component facing the sliding face.

18. The device of claim 17, wherein the counter face has one or more pocket-forming recesses for introduction of in each case at least one measurement sensing element.

19. The device of claim 18, wherein there is provided a sensor board modeled on at least a portion of the counter face and applied, including adhesively bonded, to the counter face, wherein the one or more measurement sensing elements are introduced into the pockets provided in the first component.

20. The device of claim 15, wherein the first component is manufactured from or comprises a material with high thermal conductivity and/or low thermal capacity.

21. The device of claim 20, wherein the first component is manufactured from a ceramics material including silicon carbide.

22. The device of claim 15, wherein multiple measurement sensing elements are embedded in the first component offset relative to one another, including at a constant distance from one another.

23. The device of claim 22, wherein in the case of an annular component an angular offset between the measurement sensing elements of between 80 and 100 degrees, including 90 degrees, is provided.

24. A rotating work machine, preferably a pump, including a centrifugal pump, having at least one device as claimed in claim 15 for mounting a shaft and/or for sealing a shaft with respect to a wall of the work machine.

25. The system of claim 24, wherein the system comprises an evaluation unit configured to receive the measured values of the at least one temperature sensor and to monitor the condition of the sliding bearing or of the slip-ring seal on the basis of the received measured temperature values.

26. The system of claim 25, wherein the evaluation unit is configured to recognize the condition of the sliding bearing or of the slip-ring seal on the basis of the measured temperature values and at least one further operating parameter of the work machine.

27. The system of claim 26, wherein the at least one further operating parameter is the rotation speed.

28. The system of claim 26, wherein the at least one further operating parameter is the temperature of a fluid conveyed through the work machine.

29. The system of claim 26, wherein the at least one further operating parameter is a pressure acting on the sliding bearing or the slip-ring seal.

30. The system of claim 25, wherein the evaluation unit is configured to recognize and evaluate transient phenomena in the measured temperature profile.

31. The system of claim 25, wherein previously stored correlation information between the temperature in the sealing gap or bearing gap and the temperature at the measuring point of the temperature sensor is stored in a memory of the evaluation unit.

32. The system of claim 25, wherein the evaluation unit is part of the work machine or is a central computing unit, including a cloud-based solution, that is communicatively connected to the work machine.

33. A method for producing a device as claimed in claim 15, wherein one or more pocket-like recesses are worked into the first component via a machining method.

34. The method of claim 19, wherein the machining method comprises laser ablation and at least one measurement sensing element of a temperature sensor is inserted into each pocket-like recess.
